(19) United States
(12) Patent Application Publication
(10) Pub. No.: US 2010/0203883 A1
(43) Pub. Date: Aug. 12, 2010

(54) Antenna Docking Station

(76) Inventors: Anthony DeMarco, Newport Beach, CA (US); Ulrich N. Lippuner, El Dorado Hills, CA (US); Daniel Ray Ash, Mission Viejo, CA (US)

Correspondence Address: FISH & ASSOCIATES, PC;ROBERT D. FISH, 2603 Main Street, Suite 1000, Irvine, CA, 92614-6232, US

(21) Appl. No.: 12/625,347

(22) Filed: Nov. 24, 2009

Related U.S. Application Data
(60) Provisional application No. 61/118,103, filed on Nov. 26, 2008.

(51) Int. Cl. H04W 84/06

(52) U.S. Cl. 455/427

(57) ABSTRACT

Docking stations for a wireless device are presented in which a docking station has an antenna that can communicate with the wireless device. The docking station can also have a proximity sensor that can provide a proximity data that indicate a proximity of the wireless device to the docking station. Using the proximity data, the docking station can adjust the power to the antenna such that the amount of power can be dictated based upon the proximity of the wireless device to the docking station. A wireless repeater system is also presented that has a wireless repeater and a docking station with an antenna.

This application claims the benefit of priority to U.S. provisional application having Ser. No. 61/118,103 filed on Nov. 26, 2008. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is wireless device technologies.

### BACKGROUND

Handheld wireless devices (e.g., cell phones, PDA, etc.) suffer from numerous issues due to the compact nature of the devices. For example, handheld devices often have limited reception in areas with weak coverage by the wireless carrier due to the limited space available in the handheld device for an antenna or power source. Such situations are often encountered when the device is used within a building, or especially when driving through areas having varied coverage. Ideally, users of such devices should have access to a system that can significantly boost the reception of their handheld device in an area of weak coverage.

It has yet to be appreciated that a personal repeater system can be provided to wireless device users that includes a docking station having an antenna, and that communicates with a wireless device to provide bi-directional communication between the wireless device and a repeater.

Therefore, there remains a considerable need for methods, systems, and configurations for providing antenna docking stations.

### SUMMARY OF THE INVENTION

The present inventive subject matter is drawn to systems, configurations, and methods of providing docking stations for a wireless device where the docking station includes an auxiliary antenna for the wireless device. One aspect of the inventive subject matter includes a docking station comprising an antenna receptive to a wireless device (e.g., a cell phone, game system, PDA, etc.), and a proximity sensor capable of supplying proximity data to the docking station that indicates the proximity of the wireless device. The docking station can also include a circuit configured to adjust power to the antenna as a function of the proximity data.

Another aspect of the inventive subject matter includes a wireless repeater and a satellite antenna dock that couples to the repeater. The antenna dock can include an antenna configured to be receptive to signals from a wireless device and can also include a power input.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1A presents a front view of a possible configuration of an antenna docking station for a cell phone.

FIG. 1B presents a rear view of the docking station of FIG. 1A.

FIG. 1C presents a top view of the docking station of FIG. 1A.

FIG. 1D presents a bottom view of the docking station of FIG. 1A.

FIG. 2A presents a side view of an antenna docking station that can be placed on a surface.

FIG. 2B presents another side view of the antenna docking station of FIG. 2A.

FIG. 2C presents a front view of the antenna docking station of FIG. 2A.

FIG. 3 presents a possible schematic of an antenna docking station.

### DETAILED DESCRIPTION

Preferred embodiments include docking stations for a wireless device where a docking station includes an antenna for communicating with a wireless device. Each of the wireless device and docking station can communicate via any suitable wireless technologies including BlueTooth, Zigbee, Z-Wave, 802.11, 802.16, wireless USB, or other wireless communications. Contemplated stations also include an adjustable holder having one or more adjusting members that allows for adjustment of the docking station to hold various wireless devices having different sizes or dimensions.

The docking stations can also preferably be coupled to a repeater capable of sending or receiving signals to or from a wireless network (e.g., a cell phone network). The docking station can be considered a uni-directional or a bi-directional bus between the wireless device and the repeater.

In some embodiments, the docking station can also support a power input. It is contemplated that the docking station can disseminate power to other parts in a repeater system having a repeater.

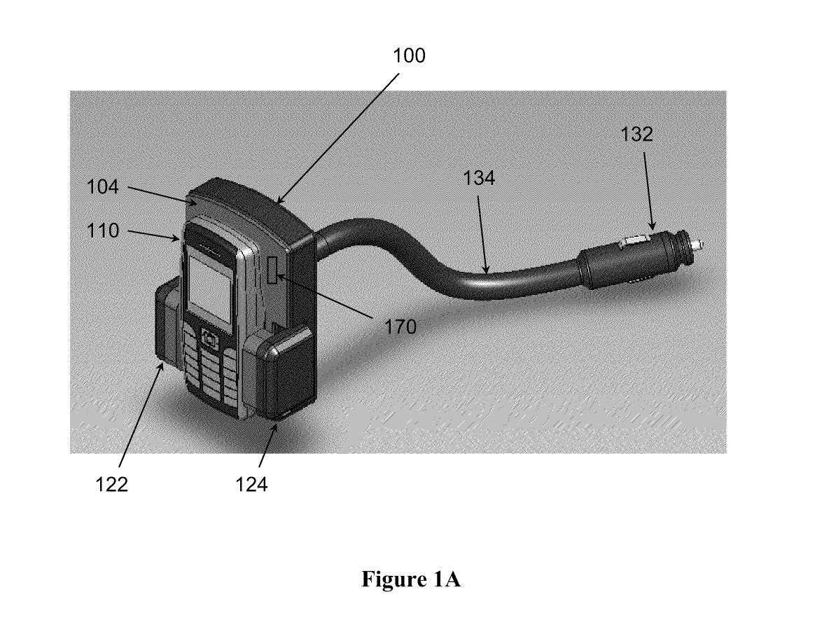

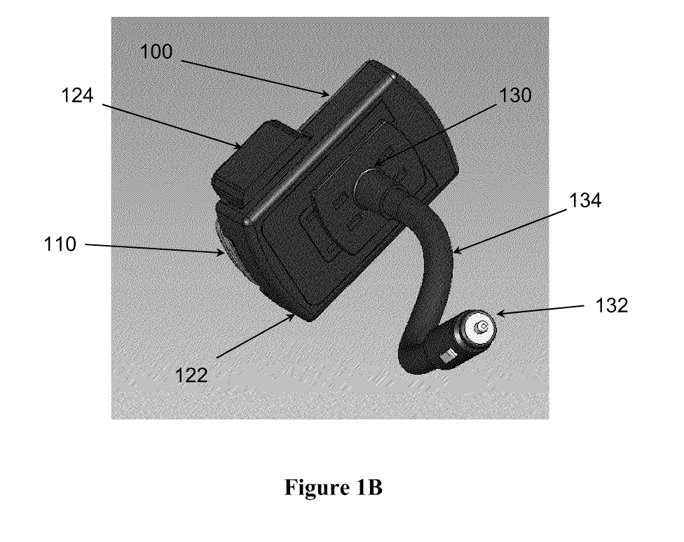

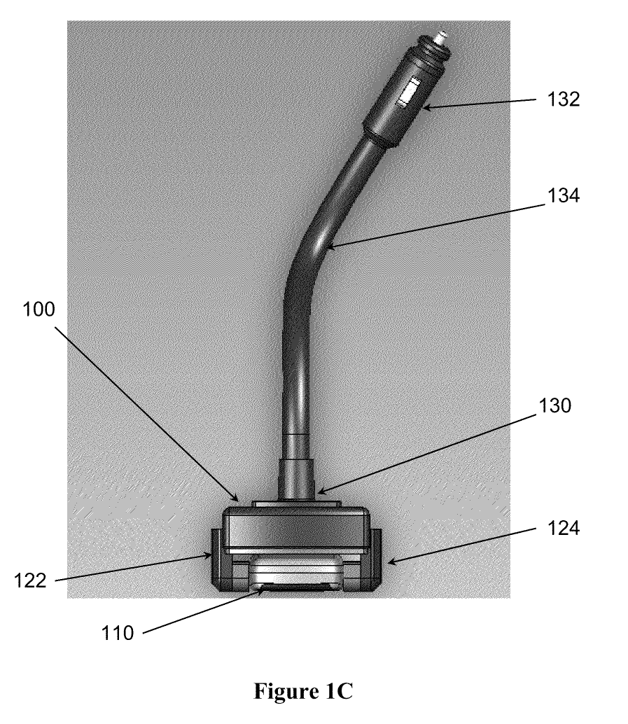

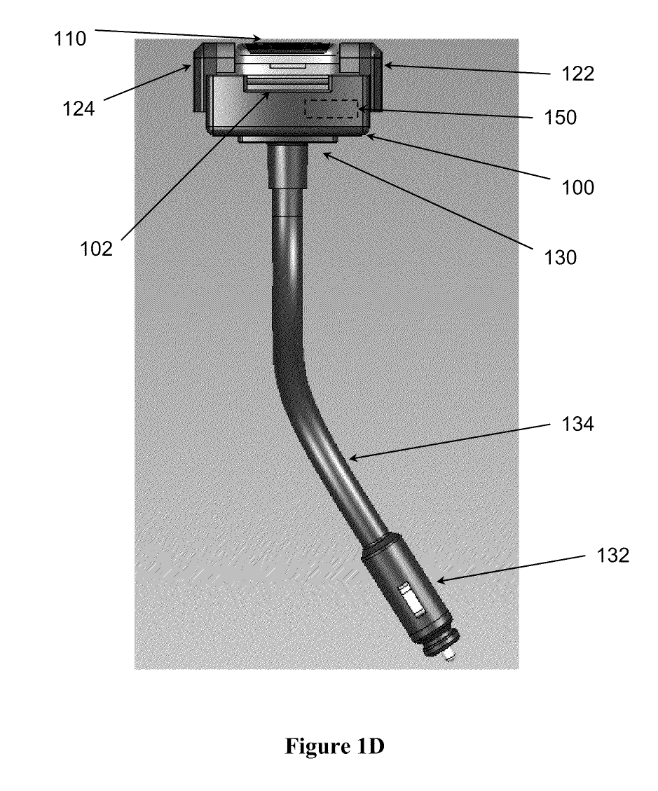

FIGS. 1A, 1B, 1C, and 1D provide various views of an example antenna docking station 100 for use in a vehicle (not shown). Although a cell phone 110 can be held in place within the docking station 100, the cell phone 110 can exchange signals with the docking station 100 without requiring the cell phone 110 or other wireless device to be in physical communication with the docking station 100 (e.g., the cell phone 110 does not have to be plugged-in). Instead, if the cell phone 110 is removed from the docking station 100, the cell phone 110 can continue to communicate with the docking station 100 wirelessly.

The docking station 100 can have a lip or other protrusion 102 coupled to the docking station 100, and that outwardly extends from a front side 104 of the docking station 100. The cell phone 110 or other wireless device can rest upon the protrusion 102, which assists the cell phone 110 in maintaining its vertical position relative to the docking station 100.

The docking station 100 can advantageously an adjustable device holder having first and second adjusting members 122 and 124 that allow the docking station 100 to hold various wireless devices including, for example, cell phones, game systems, and portable digital assistants (PDAs) for use with the docking station 100.

Each of the first and second adjusting members 122 and 124 can be laterally moved in a direction toward or away from the cell phone 110 such that the first 122 and second adjusting members 124 can be used to secure the cell phone 110 to the docking station 100 when desired. For example, to secure the cell phone 110 to the docking station 100, a user can move or direct that that first 122 and second adjusting members 124 be moved closer to the cell phone 110. Additionally, to undock the cell phone 110, the first 122 and second adjusting members 124 can be laterally moved away from the cell phone 110.

The first 122 and second adjusting members 124 can be manually moved such as by rotating a knob, gear, or other rotator that in turn causes the adjusting members 122 and 124 to laterally move toward or away from the cell phone 110. It is also contemplated that the first 122 and second adjusting members 124 alternatively could be manually moved by applying a force directly to the adjusting members 122 and 124. It is further contemplated that the docking station 100 could have a controller (not shown) that automatically moves the adjusting members 122 and 124 to secure or allow the cell phone 110 to be released from the docking station 100.

Docking station 100 can include a proximity sensor 170 that provides data indicating a proximity of cell phone 110 or other wireless device to the docking station 100. Although the sensor 170 is shown attached to the docking station 100, it is also contemplated that the sensor 170 could be disposed in an housing external from the docking station 100 and be coupled to the docking station 100 via a wired or wireless connection. Sensor 170 could be an infrared sensor or any other commercially suitable sensor that can detect a proximity of cell phone 110 or other wireless device.

The proximity data collected by the sensor 170 can be used to govern the amount of power used by the docking station 100 to remain in communication with the cell phone 110 or other wireless device. For example, the docking station 100 could use less power to send or to receive signals when the cell phone 110 is placed near to or docked with the docking station 100. Additionally, the docking station 100 could use more power to send or to receive signals when the cell phone 110 is further away from the docking station 100.

The docking station 100 can also include one or more antennas 150 that are built-in or otherwise coupled to the docking station 100. The antenna 150 can have a multi-band design such that multiple frequencies can be transmitted using a single antenna. For example, the antenna could have downlink frequencies of between 869-894 MHz and 1930-1990 MHz, and uplink frequencies of between 824-849 MHz and 1850-1910 MHz. However, the specific frequencies used by the antenna can vary depending on the application. Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Docking station 100 can also includes a power input 130 that has a plug 132 configured to be received in a cigarette lighter of a vehicle. Although typical cigarette lighters produce 12 volts of direct current, it is contemplated that the docking station 100 could optionally include or otherwise be coupled to a converter, filter, or power adapter to vary the voltage. Optionally, the cable 134 that connects the power input 130 to the plug 132 can be configured to support the weight of the docking station 100 and thereby maintain the position of the docking station 100 relative to the position of the plug 132. In addition, cable 134 can advantageously be flexible to allow a user to change the position of the docking station 100 relative to the plug 132.

Additionally or alternatively, the docking station 100 can include a battery power supply (not shown), or configured to receive power via a separate power adapter (not shown), or via a line voltage. For example, when the plug 132 is not in use, it is contemplated that the plug 132 could be decoupled from the docking station 100, and a separate power adapter (not shown) could be coupled to the docking station 100 using the same or a different connector location.

The docking station 100 could further comprise one or more light emitting diodes (LEDs) that can be used to quickly apprise a user of a power status or other system status of the docking station 100 or that a wireless device is connected to the docking station 100.

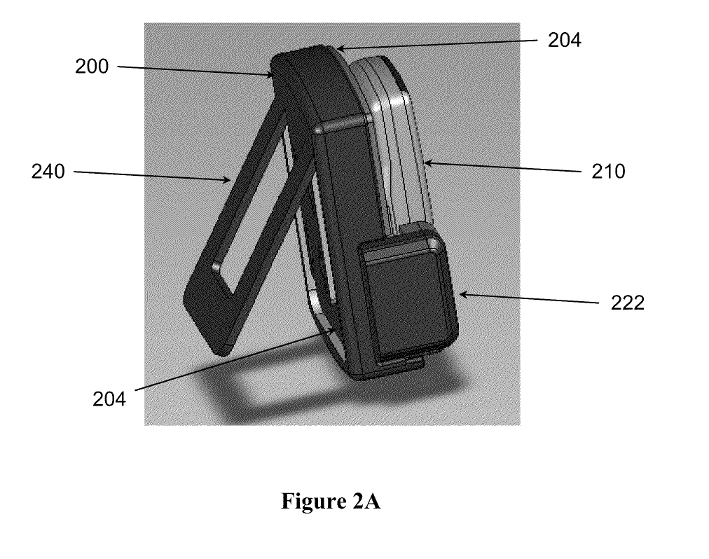

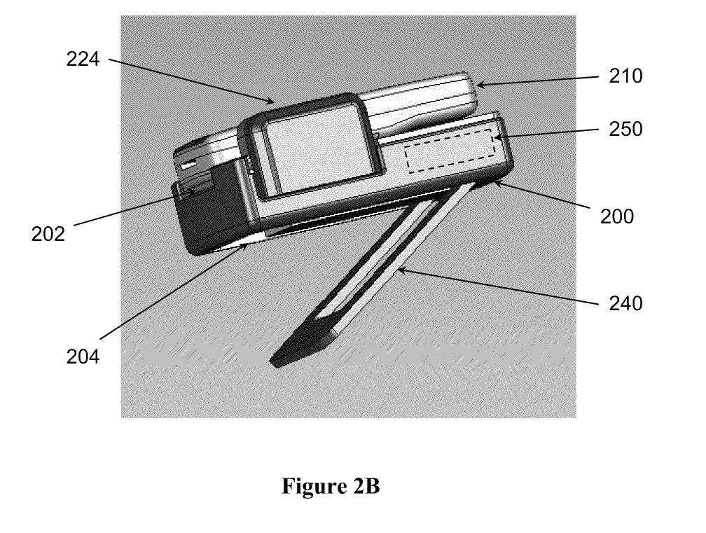

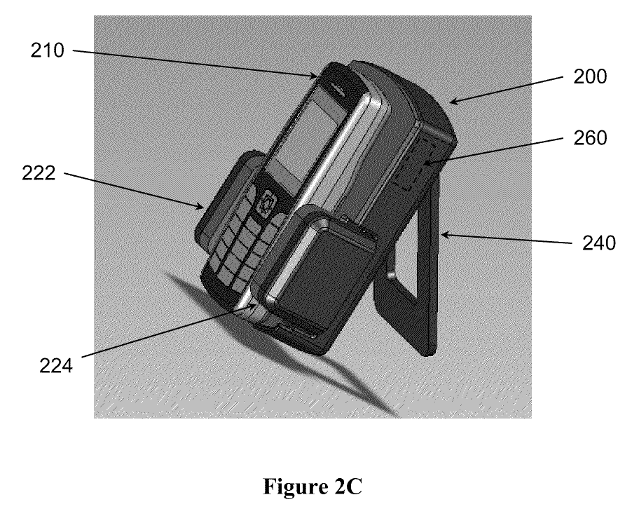

FIGS. 2A, 2B, and 2C provide various views of an example antenna docking station 200 configured for placement on a surface, possibly in a home, office, or dashboard. The docking station 200 can include a stand 240 that can be used to maintain an upright position of the docking station 200 shown in FIG. 2A. In preferred embodiments, the stand 240 can be moveably positioned within a recess 204 of the docking station 200, such that the stand 240 can be secured when not in use.

In some contemplated embodiments, docking station 200 can include a repeater 260 that is capable of sending or receiving signals to or from one or more wireless networks including, for example, a cell phone network. In other contemplated embodiments, the repeater 260 could be housed separately from the docking station 200.

In still other contemplated embodiments, the docking station 200 can include a battery power supply or be coupled to a line voltage or other power source. The docking station 200 can optionally include a power adapter that couples the docking station 200 to the power source. Such power adapters could advantageously be configured to plug into a standard power outlet. With respect to the remaining numerals in FIGS. 2A, 2B, and 2C, the same considerations for like components with like numerals of FIG. 1 apply.

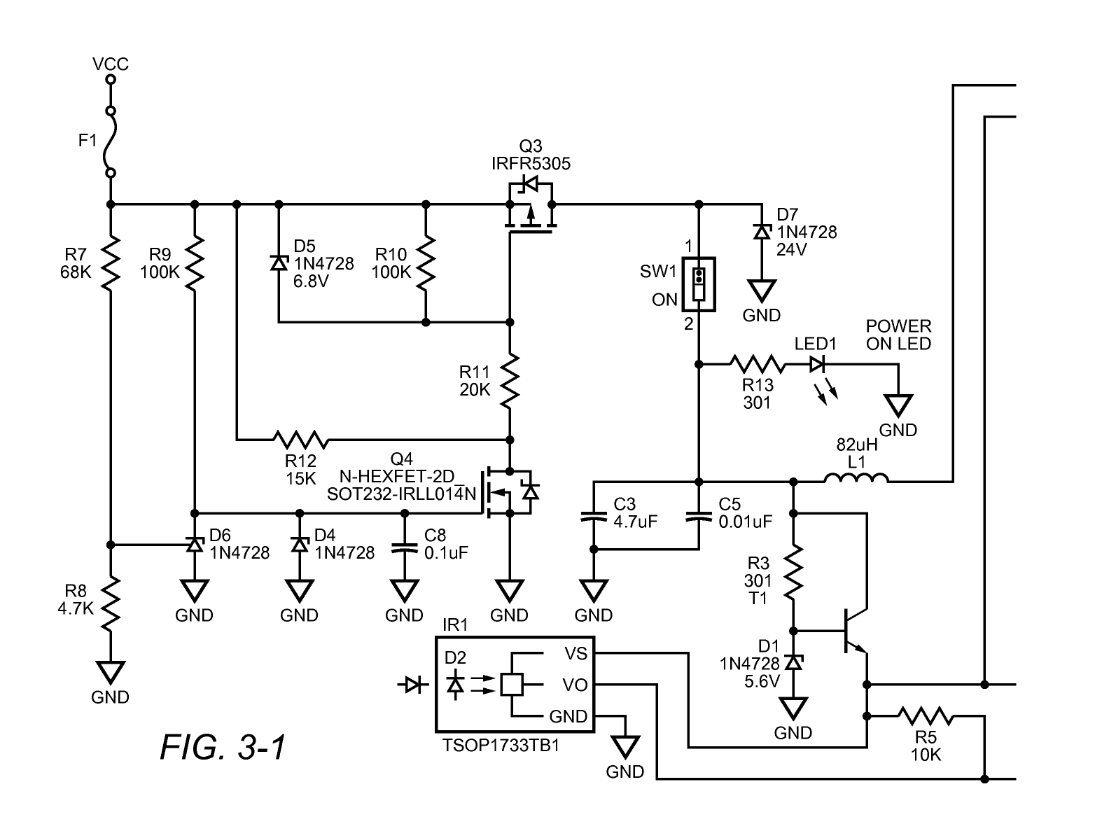

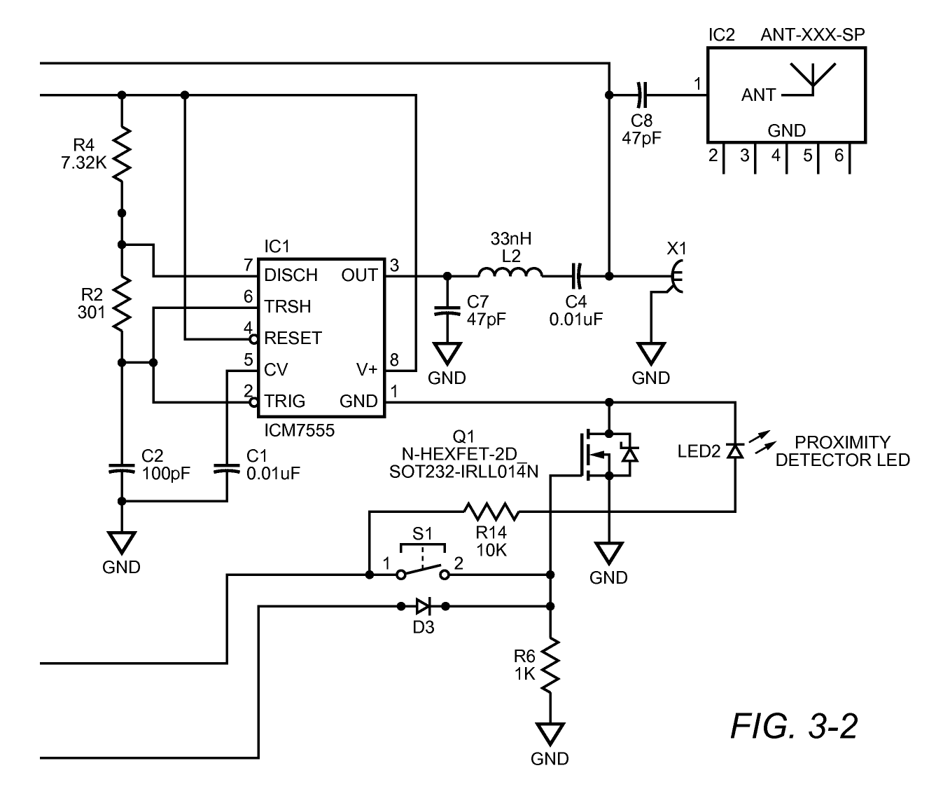

FIG. 3 provides an example schematic for a contemplated antenna docking station.

Thus, specific compositions and methods of the inventive subject matter have been disclosed. It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An antenna docking station, comprising:
an antenna receptive to signals from a wireless device;
a proximity sensor that provides data indicating a proximity of the wireless device; and
a circuit that adjusts power to the antenna as a function of the data.

2. The station of claim 1, further comprising an adjustable holder capable of retaining the wireless device.

3. The station of claim 1, further comprising a power input.

4. A wireless repeater system, comprising:
a wireless repeater; and
a satellite antenna dock communicatively coupled to the repeater, and having (a) an antenna adapted to communicate with a wireless device and (b) a power input.

5. The system of claim 1, wherein the wireless repeater and the satellite antenna dock are coupled via a wired connection.

6. The system of claim 1, wherein the antenna is receptive to a standard wireless protocol having a range of less than 100 meters.

7. The system of claim 1, further comprising a proximity sensor that provides proximity data indicating a proximity of the wireless device

8. The system of claim 7, further comprising a circuit electrically connected to the antenna that adjusts power to the antenna as a function of the proximity data.
